(19) United States
(12) Patent Application Publication
(10) Pub. No.: US 2009/0219224 A1
(43) Pub. Date: Sep. 3, 2009

(54) HEAD TRACKING FOR ENHANCED 3D EXPERIENCE USING FACE DETECTION

(76) Inventor: Johannes Elg, Helsingborg (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/039,035

(22) Filed: Feb. 28, 2008

(51) Int. Cl. G09G 5/00

(52) U.S. Cl. 345/8

(57) ABSTRACT

Embodiments of the present invention provide a system and method for enhanced rendering of a virtual environment. The system may include a portable electronic device having a video camera with a lens that faces the user, and a display. A speaker system is in communication with the portable electronic device. A head tracking application uses face detection to render a user's virtual position in the virtual environment. A video portion of the virtual environment may be rendered on the display. An audio portion of the virtual environment may be rendered in the speaker system in a manner that imitates the directional component of an audio source within the environment. The speaker system may be part of a headset in wireless communication with the portable electronic device. In one embodiment, the system is used with a 3D video gaming application.

### TECHNICAL FIELD OF THE INVENTION

The technology of the present disclosure relates generally to portable electronic devices, and more particularly to a system using head tracking by face detection to enhance a three-dimensional (3D) experience with a portable electronic device.

### DESCRIPTION OF THE RELATED ART

Portable electronic devices, such as mobile telephones, media players, personal digital assistants (PDAs), and others, are ever increasing in popularity. To avoid having to carry multiple devices, portable electronic devices are now being configured to provide a wide variety of functions. For example, a mobile telephone may no longer be used simply to make and receive telephone calls. A mobile telephone may also be a camera (still and/or video), an Internet browser for accessing news and information, an audiovisual media player, a messaging device (text, audio, and/or visual messages), a gaming device, a personal organizer, and have other functions as well.

In this vein, advancements have been made in the video capabilities of portable electronic devices. For example, a mobile telephone may have a video telephony capability that permits video calling between users. Such mobile telephones may include a camera lens that faces the user when the user makes a call. A user at the other end of the call may receive a video transmission of the image of the caller, and vice versa providing both user devices have the video telephony capability. Other advances have been made with respect to image capture, whether still photography or video. For example, cameras incorporated into portable electronic devices may now include face detection capabilities, which may detect the presence of desirable subject matter or facial features to be photographed or videoed.

There also have been attempts to provide enhanced virtual 3D experiences. For example, motion tracking has been used in virtual reality applications. As the user moves his head in various directions, motion or head tracking applications may convert the movements to adjust the user's virtual position within the virtual 3D environment. For example, if a user turns his head left, the depicted scene will respond as if user is within the virtual environment and turns to look left. Similar virtual positioning may react to a user's movements in various directions. The virtual positioning may even respond to the user moving forward or backward to give the illusion that the user is moving among objects at different virtual distances to the user. Motion tracking has proven suitable for 3D virtual reality gaming, virtual “tours” of 3D environments (homes, tourist sites, etc.), and the like. Typically, however, such virtual reality systems have not been incorporated into portable electronic devices for more convenient access.

With respect to portable electronic devices, the use of a headset in conjunction with a portable electronic device also is becoming more common. Typically, a headset will be in wireless communication with a portable electronic device, such as a mobile telephone. The wireless interface may be a Bluetooth, RF, infrared, or other wireless interface as are known in the art. Through the headset, one may make and receive telephone calls, or access other device functions, in a “hands free” mode. Some headsets now may include a head mounted display (HMD). A typical HMD may display information from a portable electronic device directly to the user's eyes. The HMD may be incorporated into a light helmet or visor type structure with display components similar in configuration to eyeglasses. Despite the ever increasing use and functionality of portable electronic devices and headsets, such devices are not being used to their full potential.

### SUMMARY

To improve the consumer experience with portable electronic devices, there is a need in the art for an improved system and method for providing an enhanced multimedia experience with a portable electronic device. Embodiments of the present invention provide a system and method for enhanced rendering of a virtual environment, which may be a three-dimensional (3D) environment within a 3D application. The system may include a portable electronic device having a video camera with a lens that faces the user, and a display. An audio speaker system is in communication with the portable electronic device. The audio speaker system may be contained in a headset in wireless communication with the portable electronic device. A head tracking application in the portable electronic device uses face detection to render a user's virtual position in the virtual 3D environment. A video portion of the 3D environment may be displayed on the display of the portable electronic device, or on an external display. The 3D environment also includes audio aspects. The head tracking may be used to render the audio portion of the 3D environment in a manner that imitates the directional component of an audio source within the 3D environment. In one embodiment, the system is incorporated into a video gaming application.

Therefore, according to one aspect of the invention, a system for rendering a virtual environment in a multimedia application comprises a portable electronic device comprising a camera for capturing a moving image of a user, a speaker system in communication with the portable electronic device for reproducing an audio portion of the virtual environment, and a display for displaying a video portion of the virtual environment. A controller is configured to receive the moving image from the camera and to use face detection to track a motion of the user from the moving image, and further to render the audio portion and the video portion of the virtual environment in a manner commensurate with the user's virtual position in the virtual environment as determined by the tracked motion of the user.

According to one embodiment of the system, the controller is located within the portable electronic device.

According to one embodiment of the system, the speaker system is part of a headset in communication with the portable electronic device.

According to one embodiment of the system, the headset is in communication with the portable electronic device over a wireless interface.

According to one embodiment of the system, the wireless interface is one of a Bluetooth, RF, infrared or Wireless LAN wireless interface.

According to one embodiment of the system, the controller is located in the headset.

According to one embodiment of the system, the headset further comprises a motion sensor for sensing the motion of a user. The controller is further configured to track the user's motion from the motion sensor, and to render the audio portion and the video portion of the virtual environment in a manner commensurate with the motion of the user based on the combination of the moving image captured by the camera and the motion sensed by the motion sensor.

According to one embodiment of the system, the system further comprises a storage device external to the portable electronic device for storing the multimedia application, wherein the portable electronic device executes the application by accessing the application from the storage device.

According to one embodiment of the system, the display is located in the portable electronic device.

According to one embodiment of the system, the display is a head mounted display located in the headset.

According to one embodiment of the system, the multimedia application is a three dimensional (3D) application.

According to one embodiment of the system, the multimedia application is a video game.

According to one embodiment of the system, the portable electronic device is a mobile telephone.

According to another aspect of the invention, a method of rendering a virtual environment in a multimedia application comprises the steps of capturing a moving image of a user with a camera, tracking a motion of the user by applying face detection to the moving image, rendering an audio portion of the virtual environment in a speaker system, and rendering a video portion of the virtual environment in a display. The rendered audio portion and the rendered video portion of the virtual environment are commensurate with a user's virtual position in the virtual environment as determined by the tracked motion of the user.

According to one embodiment of the method, the rendering steps include rendering a video portion of the virtual environment commensurate with the head tracking of the motion of the user's head to render a virtual position of the user, and rendering the audio portion of the virtual environment includes reproducing the audio portion in the speaker system in a manner that imitates a directional component of at least one audio source within the virtual environment.

According to one embodiment of the method, rendering the audio portion of the virtual environment includes reproducing the audio portion in the speaker system in a manner that imitates directional components of a plurality of audio sources within the virtual environment.

According to one embodiment of the method, the method further comprises the step of sensing the motion of the user's head with a motion sensor, and the rendering steps further comprise rendering the audio portion and the video portion of the virtual environment commensurate additionally with the user's motion as sensed by the motion sensor.

According to one embodiment of the method, the capturing and tracking steps are performed using a portable electronic device, and the speaker system is part of a headset in communication with the portable electronic device.

According to one embodiment of the method, the headset is in wireless communication with the portable electronic device.

According to one embodiment of the method, the method further comprises accessing the multimedia application from a storage device external to the portable electronic device.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

It should be emphasized that the terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of an exemplary system for providing an enhanced multimedia experience in a portable electronic device in accordance with an embodiment of the present invention.

FIG. 2 is a schematic view of a mobile telephone as an exemplary portable electronic device for use in accordance with an embodiment of the present invention.

FIG. 3 is a schematic block diagram of operative portions of the mobile telephone of FIG. 2.

FIG. 4 is a schematic block diagram of operative portions of a headset/head mounted display (HMD) for use in accordance with embodiments of the present invention.

FIG. 5 is a flowchart depicting an exemplary method of rendering a virtual environment for a multimedia application in accordance with an embodiment of the present invention.

FIG. 6 is a schematic view of another exemplary system for providing an enhanced multimedia experience in a portable electronic device in accordance with an embodiment of the present invention.

FIG. 7 is a schematic diagram of a communications system in which the mobile telephone of FIG. 2 may operate.

### DETAILED DESCRIPTION OF EMBODIMENTS

Exemplary embodiments of the present invention provide an enhanced system for rendering a virtual environment with a portable electronic device. The virtual environment may be a three-dimensional (3D) environment in a 3D application. The system includes a portable electronic device, such as a mobile telephone, that includes a camera having a lens that faces the user, and a display. The system further includes an audio speaker system in communication with the portable electronic device. The audio speaker system may be located in a headset in wireless communication with the portable electronic device, and the audio may be stereo audio or virtual surround sound audio. The system further includes a head tracking application that uses face detection of an image of the user captured by the camera to track the movement of the user's head. The movement may be translated into a user's virtual position in a 3D environment.

The 3D environment includes not only visual aspects rendered on a display, but audio aspects as well. For example, a sound that occurs to the left of the user in the virtual environment would be heard predominantly through the left audio portion of the headset. In an alternative embodiment, head tracking by face detection may be combined with motion tracking devices, such as motion sensors mounted on the headset, to better track a user's movements. The system of the present invention may be incorporated into 3D gaming, virtual tours of real and imaginary locations, and other multimedia applications in which an authentically rendered (sound and image) virtual 3D environment is desirable. Although in the preferred embodiments the virtual environment is described as being a 3D environment, it will be appreciated that the same concepts may be applied to rendering virtual two-dimensional environments as well.

Embodiments of the present invention will now be described with reference to the drawings, wherein like reference numerals are used to refer to like elements throughout. It will be understood that the figures are not necessarily to scale.

The following description is made in the context of a conventional mobile telephone. It will be appreciated that the invention is not intended to be limited to the context of a mobile telephone and may relate to any type of appropriate electronic device, examples of which include a media player, a gaming device, or a desktop or laptop computer. For purposes of the description herein, the interchangeable terms “electronic equipment” and “electronic device” also may include portable radio communication equipment. The term “portable radio communication equipment,” which sometimes hereinafter is referred to as a “mobile radio terminal,” includes all equipment such as mobile telephones, pagers, communicators, electronic organizers, personal digital assistants (PDAs), smartphones, and any communication apparatus or the like.

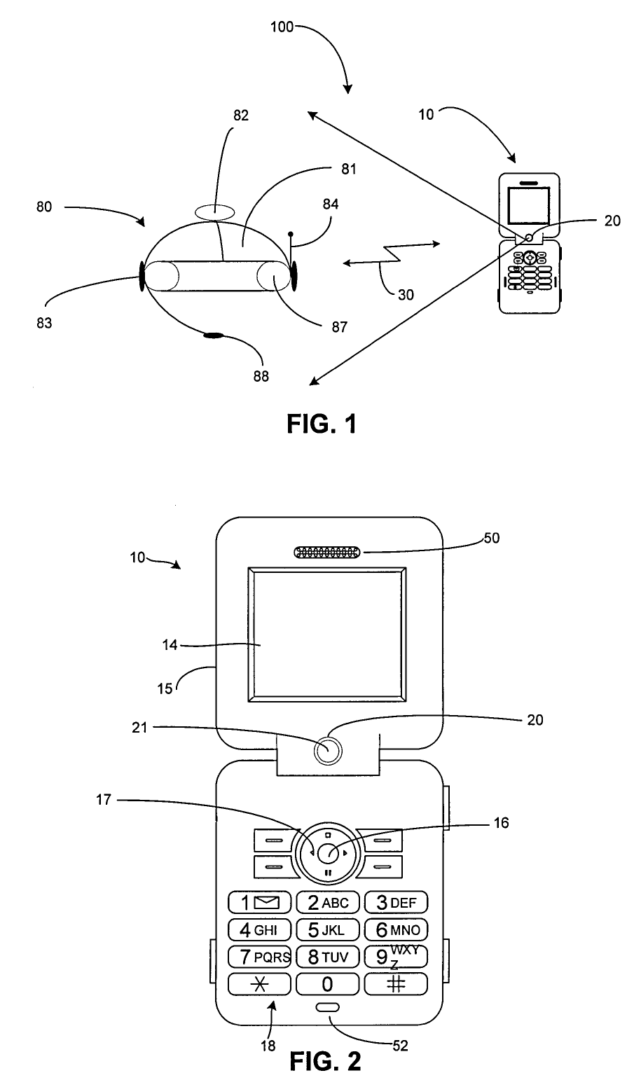

FIG. 1 is a schematic view of an exemplary system 100 for providing an enhanced multimedia experience with a portable electronic device. The exemplary system 100 includes a mobile telephone 10 and a headset 80. The mobile telephone 10 and headset 80 are in wireless communication over a short-range wireless interface 30, as represented by the jagged arrow in the figure. The wireless interface may be a Bluetooth, RF, infrared, Wireless LAN (802.11 type standard) or other wireless interface as are known in the art. In addition, although wireless communication is preferred, a wired connection between the headset 80 and the mobile telephone 10 may be employed.

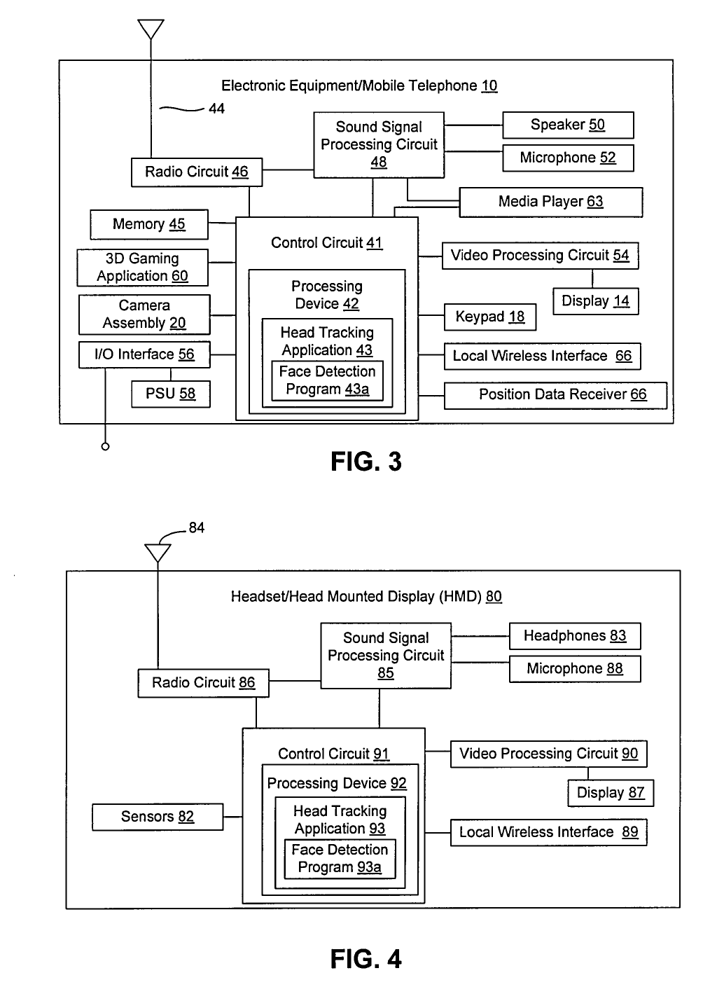

Referring additionally to FIGS. 2 and 3, FIG. 2 depicts an exemplary mobile telephone 10 for use in the system 100, and FIG. 3 represents a functional block diagram of operative portions of the mobile telephone 10. Mobile telephone 10 may be a clamshell phone with a flip-open cover 15 movable between an open and a closed position. In FIG. 2, the cover is shown in the open position. It will be appreciated that mobile telephone 10 may have other configurations, such as a “block” or “brick” configuration.

Mobile telephone 10 may include a primary control circuit 41 that is configured to carry out overall control of the functions and operations of the mobile telephone 10. The control circuit 41 may include a processing device 42, such as a CPU, microcontroller or microprocessor. Among their functions, to implement the features of the present invention, the control circuit 41 and/or processing device 42 may comprise a controller that may execute program code embodied as the head tracking application 43. It will be apparent to a person having ordinary skill in the art of computer programming, and specifically in application programming for cameras, mobile telephones or other electronic devices, how to program a mobile telephone to operate and carry out logical functions associated with application 43. Accordingly, details as to specific programming code have been left out for the sake of brevity. Also, while the code may be executed by control circuit 41 in accordance with an exemplary embodiment, such controller functionality could also be carried out via dedicated hardware, firmware, software, or combinations thereof, without departing from the scope of the invention.

Mobile telephone 10 also may include a camera assembly 20. As shown in FIG. 2, camera assembly 20 may include an inward facing lens 21 that faces toward the user when the clamshell is in the open position. In this manner, camera assembly 20 may provide a video telephony function that captures an image of the user when the user is participating in a telephone call. As further described below, camera assembly 20 also may capture an image of the user for face detection and head tracking in accordance with embodiments of the present invention. It will be appreciated that camera assembly 20 also may include and outward facing lens (not shown) for taking still photographs or moving video images of subject matter opposite the user. In an alternative embodiment, the ordinary photography and video functions may be provided by a second camera assembly distinct from the video telephony camera assembly 20 used in embodiments of the present invention.

Mobile telephone 10 has a display 14 viewable when the clamshell telephone is in the open position. The display 14 displays information to a user regarding the various features and operating state of the mobile telephone 10, and displays visual content received by the mobile telephone 10 and/or retrieved from a memory 45. Display 14 may be used to display pictures, video, and the video portion of multimedia content. For ordinary photograph or video functions, the display 14 may be used as an electronic viewfinder for the camera assembly 20. In accordance with embodiments of the present invention, display 14 also may display a video portion of a rendered virtual environment.

FIG. 4 represents a functional block diagram of operative portions of the headset 80. Referring again to FIG. 1 and additionally to FIG. 4, headset 80 may include a frame portion 81, which houses the various components. The frame portion may constitute a lightweight helmet or visor which may be worn on the user's head. The headset also may include a speaker system in the form of headphones 83, and a microphone 88. Headphones 83 and microphone 88 may be used for conversing in a telephone calling mode. Headphones 83 also may constitute a speaker system for reproducing sound to the user during multimedia applications, such as gaming, listening to music, or watching audiovisual content. In one embodiment, the headset also may include one or more sensors 82 for detecting the orientation or movement of the user's head. The sensor 82, for example, may be an accelerometer or comparable motion detector. In addition, the headset may have an antenna 84 for communication with other electronic devices. For example, as stated previously, the headset may communicate with a portable electronic device, such as the mobile telephone 10, over a short range wireless interface.

As seen in FIG. 4, the antenna 84 may be coupled to a radio circuit 86. The radio circuit 86 includes a radio frequency transmitter and receiver for transmitting and receiving signals via the antenna 84 as is conventional. The headset further includes a sound signal processing circuit 85 for processing audio signals transmitted by and received from the radio circuit 86. Coupled to the sound processing circuit 85 are the headphones 83 and microphone 88. A local wireless interface 89, such as a Bluetooth, RF, infrared, Wireless LAN (802.11 type standard) or other short distance wireless interface, may be used to transmit and receive data from other electronic devices, as is conventional.

The headset 80 also may contain a control circuit 91, which may include a processing device 92, which controls overall operation of the headset. Among their functions, to implement the features of the present invention, the control circuit 91 and/or processing device 92 may comprise a controller that may execute program code embodied as a headset head tracking application 93. Application 93 is comparable to application 43 located within the mobile telephone 10. It will be apparent to a person having ordinary skill in the art of computer programming, and specifically in application programming for cameras, mobile telephones or other electronic devices, how to program a mobile telephone to operate and carry out logical functions associated with application 93. Accordingly, details as to specific programming code have been left out for the sake of brevity. Also, while the code may be executed by control circuit 91 in accordance with an exemplary embodiment, such controller functionality could also be carried out via dedicated hardware, firmware, software, or combinations thereof, without departing from the scope of the invention.

In various embodiments, therefore, head tracking functions may be performed with either an application 43 in the mobile telephone, or alternatively by an application 93 in the headset. In one embodiment, head tracking functions may be performed with both applications 43 and 93 acting cooperatively.

In one embodiment, the headset may include one or more displays 87 to provide a head mounted display (HMD), as are known in the art. The HMDs may be mounted to the frame 81 in a manner that substantially corresponds to an eyeglass configuration. The configuration permits regular vision as well as displaying information to the user. In accordance with certain embodiments of the invention, the video portion of the virtual environment of a multimedia application may be rendered within the HMD displays. The displays 87 may be coupled to a video processing circuit 90 that converts video data to a video signal used to drive the displays.

It will be appreciated that the precise headset structure depicted in FIGS. 1 and 4 is exemplary and not intended to limit the scope of the invention. Other headset configurations may be employed. In addition, alternative embodiments may provide for a speaker system other than in a headset. For example, the speaker system may be contained within the portable electronic device, or comprise one or more stand-alone speakers.

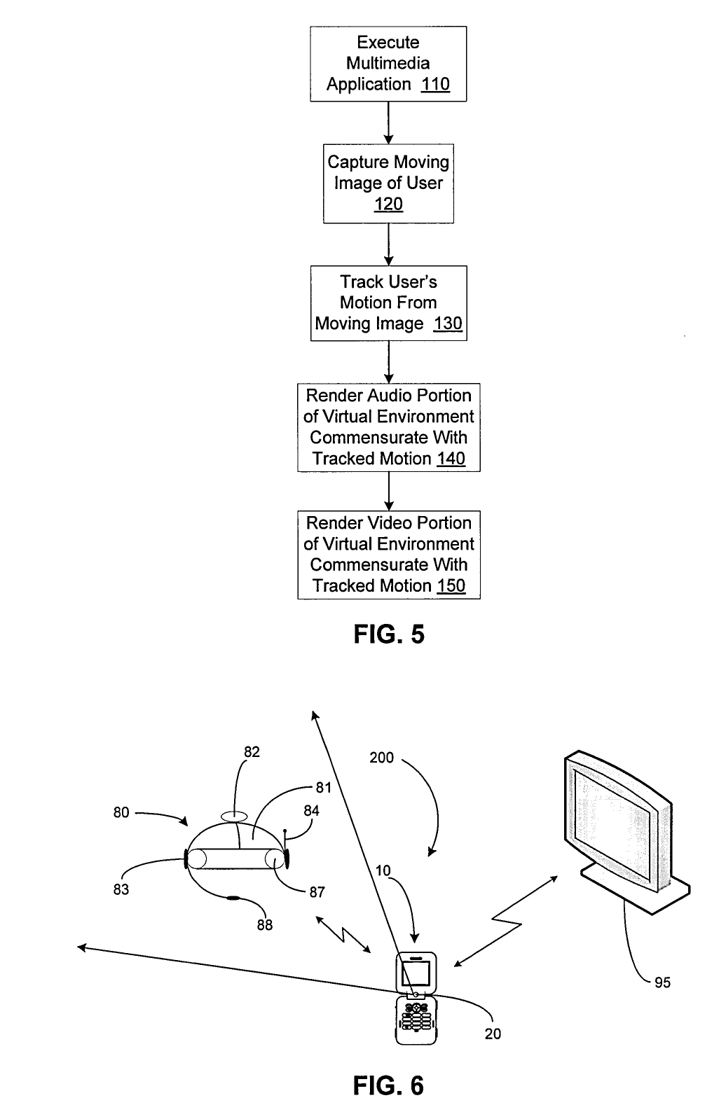

FIG. 5 depicts an overview of an exemplary method of rendering a virtual environment in a multimedia application in accordance with an embodiment of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention.

The method overview may begin at step 110 in which a user executes a multimedia application in which a virtual environment is to be rendered. At step 120, a camera captures a moving image of the user. At step 130, a motion of the user is tracked from the moving image. At steps 140 and 150, audio and video portions of the virtual environment are rendered commensurately with the tracked motion of the user. Specifically, the rendered audio and video portions of the virtual environment are commensurate with the user's virtual position in the virtual environment as determined by the tracked motion of the user.

The various aspects of using head tracking to provide an enhanced multimedia experience with a portable electronic device will now be described in greater detail. The description will be made in conjunction with a 3D gaming application, although it will be appreciated that the invention is not limited to any specific categories of applications. For example, features described herein may be employed in conjunction with any application in which a rendered virtual environment may be desirable, such as a virtual tour, video telephony and video conferencing, enhanced mobile entertainment, and the like. In addition, although the following description is made in connection with a 3D application, comparable principles may be employed with respect to two-dimensional applications as well. Generally, the features described herein may be employed in any application that may utilize the display of the portable electronic device, including the manipulation of icons or menu items as part of a virtual 3D or 2D environment rendered according to the position of the user.

In this exemplary embodiment, mobile telephone 10 may include a 3D gaming application 60 (see FIG. 3). In this example, the user may play the game as a game character in a virtual 3D environment including audio and video portions. As seen in FIG. 2, mobile telephone 10 also has a keypad 18 that provides for a variety of user input operations. For example, keypad 18 typically includes alphanumeric keys for allowing entry of alphanumeric information such as telephone numbers, phone lists, contact information, notes, etc. In addition, keypad 18 typically includes special function keys such as a “send” key for initiating or answering a call, and others. Some or all of the keys may be used in conjunction with the display as soft keys. Keys or key-like functionality also may be embodied as a touch screen associated with the display 14.

Keypad 18 also may include a five-way navigational surface 17. The navigational surface 17 may include four directional surfaces and a center “select” button 16 to provide for a variety of navigation and input functions. In accordance with embodiments of the present invention, the keypad 18 may be used to initiate a gaming session as is conventional. Features of the keypad 18 also may be used to carry out functions within the game. For example, navigation surface 17 may be used to move about the virtual environment, and select button 16 may be used to interact with items a user may come across. Other uses of the keypad 18 within the game environment may be employed.

In one embodiment, the video portion of the game may be displayed on the display 14 of the mobile telephone 10. The video content of character-based games typically may be from a first-person perspective or a third-person perspective. In the first-person perspective, the displayed content is intended to represent the rendered environment as being seen through the eyes of the user's in-game character. In the third-person perspective, the user's in-game character may be seen within the rendered environment from the perspective of an “over-the-shoulder” view from behind the character. The current invention may be employed in either perspective. The audio portions of the game may be transmitted over the short-range wireless interface to the headset 80 and heard by the user through a speaker system in the form of the headphones 83.

Like the video portions, the audio portions of the 3D game are intended to accurately represent the virtual 3D environment, so that the sound is directional. For example, sound occurring to the left of the in-game character in the virtual environment would predominantly be heard through the left headphone, and vice versa. In one embodiment, the audio capability may include a virtual surround sound feature, as is known in the art, that may imitate full directional audio through the headphones. Furthermore, although the audio portion may be rendered through a headset, other audio systems may be employed. For example, the audio portion may be rendered through speakers in the portable electronic device, or through an external system of one or more stand-alone speakers.

Head tracking application 43 of the mobile telephone 10 may be employed as follows to orient the user's in-game character within the game to enhance the 3D experience. Referring to FIG. 1, camera assembly 20 may capture an image of the user in a manner comparable to video telephony, as represented by the straight arrows in the figure. Referring to FIG. 2, head tracking application 43 may include a face detection program 43a to detect the orientation of the user's head from a visual analysis of the captured image. Alternatively or additionally, the captured image may be transmitted over the wireless interface 30 to the headset 80. Head tracking may then be performed in whole or in part by head tracking application 93 in the headset having face detection program 93a. In conjunction with the gaming application 60, the in-game character's orientation in the game may be rendered based upon the real-world, physical orientation of the user's head as determined by the head tracking application's analysis of the image captured from the camera assembly 20.

For example, a typical gaming sequence may proceed as follows. Gaming application 60 may render the user's in-game character in a virtual 3D game environment. A user may see the game environment in the display 14 of the mobile telephone, and hear sound within the game environment through the headphones 83. Suppose, for example, that at one point in the game a “roaring” sound may occur out of the line of sight of the in-game character and off to the left. As such, the source of the roar will not be apparent in the display, but the sound may be heard predominantly through the left headphone to imitate a sound originating to the left of the in-game character. The user may then physically turn or tilt his head as if moving to face toward the virtual direction of the sound. The image captured by the camera assembly 20 may now be focused more on the right side of the user's face (based on the user turning left). The face detection program of the head tracking application may detect that the user has turned his head left. In the game, the display may now depict a reorienting of the line of sight of the in-game character, such as by a screen scroll or pan. Thus, the line of sight of the in-game character shifts commensurately with the user physically turning or titling his head. When the alteration of the display is complete, the source of the roar may now be in the field of view of the in-game character. Furthermore, the sound may be altered commensurately. For example, the sound may now be louder and coming through both headphones to reflect that the in-game character is now facing the origin of the roar. In addition, although the sound reproduction has been described with respect to one audio source, the same principles may be applied to simultaneously reproduce directional audio from multiple or a plurality of audio sources within the virtual environment.

In this manner, lateral physical movement of a user's head, such as by turning or tilting, may be translated by the head tracking application into movement within the game, which commensurately alters the amplitude and directional components of the sound coming through each side of the headphones. Head tracking by face detection similarly may be used to reorient an in-game character's line of sight up and down. Furthermore, using virtual surround sound technology, as is known in the art, realistic sound above, below, and behind the user may be reproduced accurately based on head tracking the movements of the user's head.

A typical portable electronic device, such as mobile telephone 10, may have a relatively small display. Accordingly, head motions beyond a modest amount relative to the size of the display may result in the user being unable to view the display. In alternative embodiments, therefore, the video portion of the virtual 3D environment may be rendered in a display external to the mobile telephone. In one such embodiment, the video may be rendered in the HMDs 87 on the headset. Because the HMDs would move along with the user's head, the problems associated with the small display of the portable electronic device may be avoided.

FIG. 6 depicts a system 200 including another alternative display method in which the video portion of the 3D environment may be rendered on an external monitor 95, such as an LCD monitor, television, or the like. In this embodiment, the video portion may be transferred over a wireless interface to the external monitor, as represented by the jagged arrow in the figure. A wired interface alternatively may be employed. The video portion may be transmitted directly to the monitor or via a separate receiver (not shown) to which the monitor may be connected.

Referring again to FIGS. 1, 4, and 6, in an alternative embodiment, head tracking may be enhanced with one or more motion sensors 82 mounted on the headset. The sensor 82 may be an accelerometer or similar device to detect motion of the user's head. An additional input of sensed motion from the sensor 82 may be provided to the head tracking application 43 and/or 93 to permit more accurate translation of movement into the virtual environment. The use of a motion sensor may afford enhanced tracking of movements in situations in which face tracking may be less precise. For example, a motion sensor may be used to enhance tracking of motions in the form of head tilting (i.e., pointing the head/nose up and down or sideways head tilting about the vertical line) that may be more difficult to track with face detection alone.

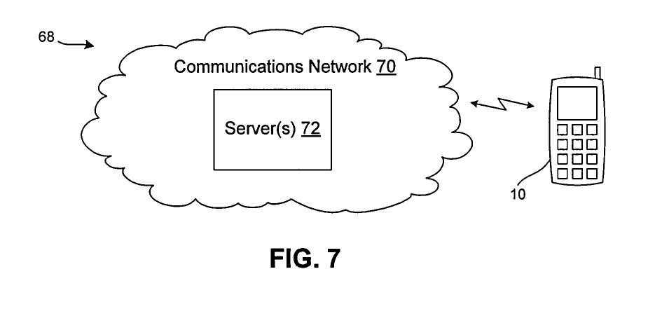

Referring to FIG. 7, the mobile telephone 10 may be configured to operate as part of a communications system 68. The system 68 may include a communications network 70 having a server 72 (or servers) for managing calls placed by and destined to the mobile telephone 10, transmitting data to the mobile telephone 10 and carrying out any other support functions. The server 72 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 70 may support the communications activity of multiple mobile telephones 10 and other types of end user devices. As will be appreciated, the server 72 may be configured as a typical computer system used to carry out server functions and may include a processor configured to execute software containing logical instructions that embody the functions of the server 72 and a memory to store such software.

In accordance with embodiments of the present invention, server 72 of communications network 70 also may constitute a storage device for storing multimedia applications. In such an embodiment, the multimedia application may be executed by accessing the multimedia application from the storage device. For example, the application may be executed by streaming the video and audio portions of the application to the mobile telephone 10, or by executing the multimedia application directly off the server. Multimedia applications may also be downloaded from the server 72 and stored in a memory 45 of the mobile telephone.

Referring again to FIG. 2, additional features of the mobile telephone 10 will now be described. For the sake of brevity, generally conventional features of the mobile telephone 10 will not be described in great detail herein.

The mobile telephone 10 includes call circuitry that enables the mobile telephone 10 to establish a call and/or exchange signals with a called/calling device, typically another mobile telephone or landline telephone, or another electronic device. The mobile telephone 10 also may be configured to transmit, receive, and/or process data such as text messages (e.g., colloquially referred to by some as “an SMS,” which stands for short message service), electronic mail messages, multimedia messages (e.g., colloquially referred to by some as “an MMS,” which stands for multimedia message service), image files, video files, audio files, ring tones, streaming audio, streaming video, data feeds (including podcasts) and so forth. Processing such data may include storing the data in the memory 45, executing applications to allow user interaction with data, displaying video and/or image content associated with the data, outputting audio sounds associated with the data and so forth.

The mobile telephone 10 may include an antenna 44 coupled to a radio circuit 46. The radio circuit 46 includes a radio frequency transmitter and receiver for transmitting and receiving signals via the antenna 44 as is conventional. The mobile telephone 10 further includes a sound signal processing circuit 48 for processing audio signals transmitted by and received from the radio circuit 46. Coupled to the sound processing circuit 48 are a speaker 50 and microphone 52 that enable a user to listen and speak via the mobile telephone 10 as is conventional.

The display 14 may be coupled to the control circuit 41 by a video processing circuit 54 that converts video data to a video signal used to drive the various displays. The video processing circuit 54 may include any appropriate buffers, decoders, video data processors and so forth. The video data may be generated by the control circuit 41, retrieved from a video file that is stored in the memory 45, derived from an incoming video data stream received by the radio circuit 48 or obtained by any other suitable method.

The mobile telephone 10 also may include a media player 63. The media player 63 may be used to present audiovisual content to the user which may include images and/or sound together or individually, such as photographs or other still images, music, voice or other sound recordings, movies, mobile television content, news and information feeds, streaming audio and video, and the like.

The mobile telephone 10 also may include an I/O interface 56 that permits connection to a variety of I/O conventional I/O devices. One such device is a power charger that can be used to charge an internal power supply unit (PSU) 58.

Although the invention has been shown and described with respect to certain preferred embodiments, it is understood that equivalents and modifications will occur to others skilled in the art upon the reading and understanding of the specification. The present invention includes all such equivalents and modifications, and is limited only by the scope of the following claims.

What is claimed is:

1. A system for rendering a virtual environment in a multimedia application comprising:
a portable electronic device comprising a camera for capturing a moving image of a user;
a speaker system in communication with the portable electronic device for reproducing an audio portion of the virtual environment;
a display for displaying a video portion of the virtual environment; and
a controller configured to receive the moving image from the camera and to use face detection to track a motion of the user from the moving image, and further to render the audio portion and the video portion of the virtual environment in a manner commensurate with the user's virtual position in the virtual environment as determined by the tracked motion of the user.

2. The system according to claim 1, wherein the controller is located within the portable electronic device.

3. The system according to claim 1, wherein the speaker system is part of a headset in communication with the portable electronic.

4. The system according to claim 3, wherein the headset is in communication with the portable electronic device over a wireless interface.

5. The system according to claim 4, wherein the wireless interface is one of a Bluetooth, RF, infrared, or Wireless LAN wireless interface.

6. The system according to claim 3, wherein the controller is located in the headset.

7. The system according to claim 3, wherein the headset further comprises a motion sensor for sensing the motion of a user, and the controller is further configured to track the user's motion from the motion sensor, and to render the audio portion and the video portion of the virtual environment in a manner commensurate with the motion of the user based on the combination of the moving image captured by the camera and the motion sensed by the motion sensor.

8. The system according to claim 1 further comprising a storage device external to the portable electronic device for storing the multimedia application, wherein the portable electronic device executes the application by accessing the application from the storage device.

9. The system according to claim 1, wherein the display is located in the portable electronic device.

10. The system according to claim 3, wherein the display is a head mounted display located in the headset.

11. The system according to claim 1, wherein the multimedia application is a three dimensional (3D) application.

12. The system according to claim 1, wherein the multimedia application is a video game.

13. The system according to claim 1, wherein the portable electronic device is a mobile telephone.

14. A method of rendering a virtual environment in a multimedia application comprising the steps of:
capturing a moving image of a user with a camera;
tracking a motion of the user by applying face detection to the moving image;
rendering an audio portion of the virtual environment in a speaker system; and
rendering a video portion of the virtual environment in a display;
wherein the rendered audio portion and the rendered video portion of the virtual environment are commensurate with a user's virtual position in the virtual environment as determined by the tracked motion of the user.

15. The method according to claim 14, wherein the rendering steps include rendering a video portion of the virtual environment commensurate with the head tracking of the motion of the user's head to render a virtual position of the user, and rendering the audio portion of the virtual environment includes reproducing the audio portion in the speaker system in a manner that imitates a directional component of at least one audio source within the virtual environment.

16. The method according to claim 15, wherein rendering the audio portion of the virtual environment includes reproducing the audio portion in the speaker system in a manner that imitates directional components of a plurality of audio sources within the virtual environment.

17. The method of claim 14 further comprising the step of sensing the motion of the user's head with a motion sensor, and the rendering steps further comprise rendering the audio portion and the video portion of the virtual environment commensurate additionally with the user's motion as sensed by the motion sensor.

18. The method of claim 14, wherein the capturing and tracking steps are performed using a portable electronic device, and the speaker system is part of a headset in communication with the portable electronic device.

19. The method of claim 18, wherein the headset is in wireless communication with the portable electronic device.

20. The method according to claim 14 further comprising accessing the multimedia application from a storage device external to the portable electronic device.
